(19) United States
(12) Patent Application Publication
(10) Pub. No.: US 2012/0148707 A1
(43) Pub. Date: Jun. 14, 2012

(54) WATER FILTRATION AND FLAVOR ADDITIVE DEVICE

(75) Inventors: ROBERT WILLIAM LACKEY, Hickory, NC (US); ROBERT CHARLES BECKMAN, Vale, NC (US); ANDREW FREDERICK FAY, Granite Falls, NC (US); JERRI LYNN LEMKE, Hickory, NC (US)

(73) Assignee: PROTECT PLUS, LLC, Hickory, NC (US)

(21) Appl. No.: 13/164,341

(22) Filed: Jun. 20, 2011

Related U.S. Application Data
(60) Provisional application No. 61/356,386, filed on Jun. 18, 2010.

(51) Int. Cl. A47J 31/44; A47J 31/46; A23L 2/56

(52) U.S. Cl. 426/66; 99/290

(57) ABSTRACT

The present invention provides methods and systems for a water filtration and flavor additive device that includes a lower reservoir for storing filtered water having a base and a top portion, an upper reservoir, a filter housing affixed to and extending below the upper reservoir. The filter housing is adapted to contain a filter cartridge wherein the upper reservoir and the filter housing are in liquid communication. The device further includes a mixing chamber for receiving a flavor additive and allowing for the mixture of the flavor additive and filtered water.

### CROSS REFERENCE TO RELATED PATENT APPLICATION

The current application claims the benefit of the earlier priority filing date of provisional application Ser. No. 61/356,386 that was filed on Jun. 18, 2010.

### FIELD OF THE INVENTION

The present invention relates generally to a liquid filtration device typically used in residential applications or in any application where a filtered liquid is desired. The invention more specifically relates to a water filtration device that possesses the ability to infuse filtered water with an additive.

### BACKGROUND OF THE INVENTION

Water is a basic necessity to sustain all life. Every living thing on the planet, animal and plant, needs water to survive. As such, the need for clean, pure water will never decrease. In fact, as populations grow, the need for clean, pure water will only increase. Recently, society has begun to focus more on the purity of water for both drinking and other applications. Pure water is bottled by a multitude of manufacturers and is sold in many places. Demand for pure bottled water is increasing and shows no signs of waning.

The medical community in the United States periodically issues statements that indicate the average person does not drink enough water. Unlike soda, milk, and other beverages, water is available to most people simply by turning on a faucet. Typically, a local utility company provides water to people. The utility company is generally responsible for ensuring that the water provided to homes and businesses is clean, pure, and free from harmful organisms. Indeed, many people rely solely on the public water systems to guarantee that the water flowing into their homes and businesses is fit for consumption. Typically, the municipal body responsible for providing water to the populace will have various treatment and purification procedures to help ensure the quality of the water provided to consumers. These systems can include large, industrial scale filters, treatment tanks, and other water processing devices. Unfortunately, sometimes these systems can break down, or these systems can miss a contaminant leaving the treated water with various forms of impurities.

Since water is such a vital part of people's everyday needs, the desire for clean, pure water continues to grow. Most municipal treatment facilities do an adequate job in cleaning and purifying water, however, there is concern that the municipal systems responsible for providing clean, pure water are simply overworked. Filtration of water on such a large scale can sometimes lead to water that contains particulate filtrate material left over from where the water was originally filtered. Moreover, some of the treatment methods and additive chemicals used in the cleaning and purifying of water can leave the water containing undesirable contaminants.

Municipal water treatment systems typically focus on removing various contaminants from water in order to provide clean, potable water for human consumption. Large scale purification of water is designed to reduce or eliminate the concentration of particulate matter including suspended particles, parasites, bacteria, algae, viruses, and fungi. Also, the municipal treatment facilities have apparatuses and methods to remove a wide range of dissolved and particulate material picked up by water from the surfaces the water may have made contact with after falling as rain and flowing to the treatment facility.

In the United States, the standards for drinking water quality are typically set by the government and have certain thresholds designed to ensure the drinking water is safe for consumption. In other countries around the world, however, the standards and thresholds for certain contaminants are not as stringent. Thus the warning of “don't drink the water,” in various places around the world.

According to a 2007 World Health Organization report, 1.1 billion people lack access to an improved drinking water supply. The WHO estimates that 88% of the 4 billion annual cases of diarrheal disease are attributed to unsafe water and inadequate sanitation and hygiene. Further, 1.8 million people die from diarrheal diseases each year. The WHO further estimates that 94% of these diarrheal cases are preventable through modifications to the environment, including access to safe water. The WHO concludes that a few simple techniques for treating water at home, such as chlorination, filters, and solar disinfection, combined with storing it in safe containers could save a huge number of lives each year.

In most cases, it is not possible to tell whether water is of an appropriate quality by visual examination. If water has a cloudy appearance or there are visible particles present, then the water is most likely unsafe to drink. However, many dangerous contaminants are simply too small to be visible to the naked eye. It is impossible to know that the water is clean, pure, and fit to drink simply by looking at it. Thus, some simple procedures such as boiling or the use of a household activated carbon filter have been devised in an attempt to clean and purify water for drinking. Unfortunately, these simple steps are not sufficient for treating all the possible contaminants that may be present in water from an unknown source. Even natural spring water, which in the nineteenth century was considered safe for all practical purposes, must now be tested before determining what kind of treatment, if any, is needed. A chemical analysis of water, while expensive, is the only way to obtain the information necessary for deciding on the appropriate method of purification.

Thus, a need exists for a simple, easy to use device that will ensure that water is clean, pure, and does not contain harmful contaminants. More specifically, a need exists for a filter capable of residential use or recreational use that will allow persons to be assured that any contaminants left in water after the municipal treatment of the water are removed prior to drinking. More particularly, there are growing desires from people for a water filter for use in residences that will provide clean, purified water to the homeowner. People want a device that will hold water and purify the water prior to its consumption. As such, water pitchers equipped with filters for filtering water as it is poured from the pitcher have become increasingly popular.

In most cases, it is not possible to tell whether water is of an appropriate quality by visual examination. If water has a cloudy appearance or there are visible particles present, then the water is most likely unsafe to drink. However, many dangerous contaminants are simply too small to be visible to the naked eye. It is impossible to know that the water is clean, pure, and fit to drink simply by looking at it. Thus, some simple procedures such as boiling or the use of a household activated carbon filter have been devised in an attempt to clean and purify water for drinking. Unfortunately, these simple steps are not sufficient for treating all the possible contaminants that may be present in water from an unknown source. Even natural spring water, which in the nineteenth century was considered safe for all practical purposes, must now be tested before determining what kind of treatment, if any, is needed. A chemical analysis of water, while expensive, is the only way to obtain the information necessary for deciding on the appropriate method of purification.

In addition to concerns over the quality of water found in various parts of the world, health professionals are continually espousing the need for people in every country to drink more water. In the United States, a person's choice of available beverages is immense. In addition to water, a consumer in the United States is often confronted with a daunting number of choices of beverages. For example, one can choose soda, milk, fruit juice, energy drinks, beer, wine, or liquor. And, further complicating the matter, there are a multitude of variations on these categories of drinks available to people. With soda alone, people have many choices. Often times, people choose to drink a soda or fruit juice (often times not even made from real fruit) instead of selecting pure water.

One of the reasons people elect to drink beverages other than water are that these other drinks contain salts, caffeine, colors, acids, high fructose corn syrup, and other flavors that tend to entice people. Most of these products are based on water, but contain so many additives that the result is a drink that, while based on water, contains large amounts of unhealthy additives. For example, unlike pure water that has zero calories, zero sugars, and zero sodium in twelve ounces, one twelve-ounce can of Coke has 140 calories, fifty milligrams of sodium, and thirty-nine grams of sugar. These ingredients pose health risks to the average person at large concentrations. Despite the health risks of consuming large amounts of these ingredients, the fact is that to most people, they taste good.

Indeed, water, while undoubtedly very healthy, does not have a distinct taste. Conversely, soda, juice, alcoholic drinks, milk, tea and other drinks have very distinctive tastes that are normally quite appealing to the average person. Moreover, many of the drinks have distinct scents and fragrances that are also appealing to the average person. Recent studies have begun to indicate that a person can even become addicted to ingredients such as sugars and caffeine found in some drinks further influencing that person to select a beverage other than water.

Various efforts to provide additives to water in an effort to increase the appeal of water as a drink have met with reasonable success. Tea, for example, is simply the addition of naturally growing plant matter to hot water. Various ingredients in the plant matter seep into the water thus infusing the water with a pleasant flavor. Many different kinds of teas are now widely available, and people can even combine different teas for their own special blends. Also, the sports drink industry has for years been adding salts and electrolytes to water in an effort to provide a drink that has the benefits of water with the additional benefits found in the salts and electrolytes. However, these prepackaged drinks are already blended and do not provide a means for persons to control the amount of additional substances that are blended with their water.

Various companies have introduced bottled water infused with flavors, vitamins, or other additives. The infused water prepackaged as bottle water, however, has several inherent flaws. The bottles that bottled water is packaged in lead to a significant amount of waste. Either the empty bottles end up in a landfill, or they go through an expensive recycling program. This is a concern to many people who are seeking to minimize detrimental effects on the environment. Further, even if a consumer wanted to purchase bottled water, the consumer is limited to the flavors, minerals, and other additives that the bottled water manufacturer chooses to put in the bottles. Moreover, the consumer is limited to the specific concentration of the flavors or other additives that come prepackaged in the bottled water. Also, a consumer who purchases flavored bottled water has no way of changing the flavor without buying more bottled water. Once the consumer uses up the bottled water, there is no option to reuse the container the bottled water came in to make more flavored water.

Thus, a need exists for a simple, easy to use device that will ensure that a persons' drinking water is clean, pure, does not contain harmful contaminants, and tastes good. More specifically, a need exists for a water filter device capable of residential use or recreational use that will allow persons to be assured that any contaminants left in water after the municipal treatment of the water are removed prior to drinking and that will also allow a person to add a flavor or ingredient to the filtered water prior to drinking. More particularly, there are growing desires from people for a water filter for use in residences that will provide clean, purified water to the homeowner and allow the homeowner to control additives in the purified water to enhance taste or health benefits. People want a device that will purify the water prior to its consumption, and allow them to add a flavor, vitamin, electrolyte, or other desirable additive. Further, people want a device that minimizes the detrimental effects on the environment.

Thus, a need exists for a device that is capable of satisfying these various desires. These desires and goals can be achieved by use of a pitcher or container equipped with a water filter and a device to transfer an additive to the filtered water. A pitcher or container provides a user with the ability to store the filtered water in a refrigerator, or transport the filtered water from place to place. Several pitcher products are currently available, but none has the advantages of the present invention.

While there are many water pitchers currently available that contain a filter, these pitchers do not provide a means by which a user can add a flavor or other additive to the filtered water. Persons who want to add something to the filtered water are left with few options. Generally, to add something to the purified, filtered water, a user must open the filter pitcher and dump the additive into the filtered water. This is problematic because opening the filter pitcher risks contamination of the filtered water within the pitcher and in some cases risks contamination of the filter cartridge itself. In the case of additives that are in a solid or powder form, in order to blend the additive with the filtered water, the water must be stirred. Thus, a spoon, or other stirring device must be placed into the filtered water to stir. This exposes the filtered water to any impurity or contaminate that may be on the spoon or stirring device. As such, no good way currently exists to ensure the filtered water remains filtered and yet add a flavor or other additive to the filtered water. Currently there are a number of water pitcher filter devices known in the prior art, yet none of them meets the current need.

U.S. Pat. No. 7,670,479 to Arett et al. (“Arett”) discloses and teaches a water pitcher that contains a device for adding additives to water. The Arett device consists of multiple reservoirs that are designed to hold water and additive. When the user picks up the pitcher, the user can activate a pump that will release additive into a receiving vessel along with the water. The additive is kept separate from the water and is never blended while still in the pitcher. Thus, when pouring, the pitcher is actually pouring two liquids, the water and the additive. In another embodiment, the additive is pumped into a second reservoir. As the user tilts the pitcher to pour water out, the additive pours form the second reservoir out of the pitcher as water is poured out of the water reservoir. Again, the additive is not blended with the water while in the pitcher. Arett also discloses that a filter can be incorporated into the pitcher. In this embodiment, Arett teaches that the filter component of the device is used to filter the water prior to addition of the additive in the receiving vessel. Importantly, Arett requires that the pitcher have a surface downstream from the additive dispensing system that is ultrahydrophobic, ultralyophobic, or ultraclean. Arett discloses that this surface keeps the pour spout of the pitcher free from bacteria build up and other contaminants. Arett does not disclose a pitcher that can accommodate mixing an additive with filtered water within the pitcher itself. Rather, the user adds the additive to the receiving vessel as the pitcher is tilted and the water in the pitcher flows out and into the receiving vessel.

U.S. Pat. No. 5,724,883 to Usherovich discloses and teaches an apparatus that provides a way to include an additive in filtered water. Specifically, Usherovich discloses and teaches a coffee maker. The device provides a way to route water into the device and expose the water to an additive, in this case coffee. The additive is added to the water and the water is passed through a standard coffee filter before being directed out of the device into a receiving vessel. This device allows the user to complete the addition of the additive prior to the water exiting the device, but the addition of the additive occurs prior to the water being passed through the filter. Moreover, the filter used in this device is simply a standard paper filter and is designed only to remove particulate matter from the water after the coffee additive is added.

U.S. Pat. No. 4,660,741 to Kirschner et al. (“Kirschner”) discloses and teaches yet another device and method to add an additive to filtered water. Kirschner discloses and teaches a post-mix beverage dispenser typically used for carbonated drinks in restaurants. The device includes a flavor concentrate (the additive) and a carbonator to convert the water into carbonated water. The device also includes a filter where the carbonated water is filtered before the addition of the additive. Kirschner also discloses an agitator and means to refrigerate the water in the reservoir.

U.S. Pat. No. 5,318,791 to Millman et al. (“Millman”) discloses and teaches a infusion device designed to infuse water with an additive. Millman teaches a vessel that is equipped with a screw-top lid containing a tube that protrudes downwardly into the vessel. A bag containing an additive with a string attached is placed in the vessel and the string is fitted into the tube. The tube ensures that the bag with the additive remains submerged in the water inside the vessel. The device is also equipped with a dispenser for granulated sugar and the like. While this device includes a means to infuse water with an additive, it does not contain a filter. Moreover, the water in the device is not filtered nor does it pass through a filter prior to being poured into a receiving vessel.

Therefore, a need exists for a water pitcher that will filter water and provide a means or more than one means to add an additive to the filtered water that does not suffer from the disadvantages of standard water pitchers.

While there are methods and devices described in the prior art that allow one to add an additive to filtered water, none of the devices known in the art possesses the advantages of the present invention. Problems with the prior art include the inability to store the filtered water with the additive in a convenient article for home use or recreational use. Further, the prior art pitcher devices do not allow the mixing of the additive with the filtered water within the pitcher itself. A further problem with the current devices prevalent in the prior art is that the additive is often added prior to filtering the water. In the case of a coffee maker or a soda machine, this is acceptable. However, the filters in these devices are only designed to remove particulate matter from the water. These filters do not provide purified, filtered water. Filtering the water after the additive is added is counterproductive, as the filter can remove some of the additive.

### BRIEF SUMMARY OF THE INVENTION

According to an embodiment of the present invention, the present invention is a water filtration and flavor additive device that includes a lower reservoir for storing filtered water having a base and a top portion, an upper reservoir, a filter housing affixed to and extending below the upper reservoir. The filter housing is adapted to contain a filter cartridge wherein the upper reservoir and the filter housing are in liquid communication. The device further includes a mixing chamber for receiving a flavor additive and allowing for the mixture of the flavor additive and filtered water.

According to yet another embodiment of the present invention, the water filtration and flavor additive device that includes an upper portion of the lower reservoir that contains a shelf for receiving a retention ring that contains the mixing chamber, and the retention ring contains a cavity for receiving the upper reservoir forming a passageway for allowing filtered water stored within the lower reservoir to flow through the passageway and into the mixing chamber.

According to yet another embodiment of the present invention, the water filtration and flavor additive device that includes a spout disposed on the mixing chamber.

According to yet another embodiment of the present invention, the water filtration and flavor additive device that includes a flange disposed on the upper reservoir and extending into the mixing chamber, wherein the flange is angled for diverting the filtered water into the mixing chamber.

According to yet another embodiment of the present invention, the water filtration and flavor additive device that includes a water wall forming one side of the mixing chamber and the water wall contains a plurality of bores for allowing filtered water to flow into the mixing chamber.

According to yet another embodiment of the present invention, the water filtration and flavor additive device that includes a pitcher top that is engaged to the top portion of the lower reservoir.

According to yet another embodiment of the present invention, the water filtration and flavor additive device that includes a pitcher top that is engaged to the top portion of the lower reservoir that includes a lid for providing access to the upper reservoir and the mixing chamber.

According to yet another embodiment of the present invention, the present invention is a method of water filtration and adding flavor to water in a pitcher that includes providing a water filter pitcher wherein the water filter pitcher includes a lower reservoir having a base and a top portion for storing filtered water. An upper reservoir is also contained within the pitcher for holding unfiltered water and a filter housing is affixed to and extends below the upper reservoir. The filter housing is adapted to contain a filter cartridge wherein the upper reservoir and the filter housing are in liquid communication. The pitcher further includes a mixing chamber for receiving a flavor additive. The method involves adding water to the water filter pitcher, permitting water to pass through the filter cartridge, collecting filtered water in the lower reservoir, and tilting the pitcher to allow the filtered water to pass through the mixing chamber, causing the filtered water to mix with flavor additive.

According to yet another embodiment of the present invention, the method includes a pod having a base, a top, and a flavor additive contained within the pod and placing the pod in an opening of the device for depositing the flavor additive into the mixing chamber.

### BRIEF DESCRIPTION OF THE DRAWINGS

The present invention is illustrated and described herein with reference to the various drawings, in which like reference numbers denote like method steps and/or system components, respectively, and in which:

FIG. 1 is a perspective view of the water filtration and flavor additive device;

FIG. 2 is exploded view of the water filtration and flavor additive device;

FIG. 3 is a perspective view of the water filtration and flavor additive device prior to insertion of a pod;

FIG. 4 is partial cut-away view of the water filtration and flavor additive device after a pod has been inserted into the flange and flavor additive is dispersed into the mixing chamber;

FIG. 5 is a partial cut-away view showing the flavor additive and filtered water mixing within the mixing chamber;

FIG. 6 is a perspective view of the water filtration and flavor additive device pouring flavored filtered water from the spout;

FIG. 7 is a bottom, perspective view of the flange for opening a pod;

FIG. 8 is a cut-away view of the flange with a pod inserted within the band;

FIG. 9 is a cut-away view of the flange showing the opening device of the flange opening the top of the pod; and

FIG. 10 is a top view of the flavor mixing device.

### DETAILED DESCRIPTION OF THE INVENTION

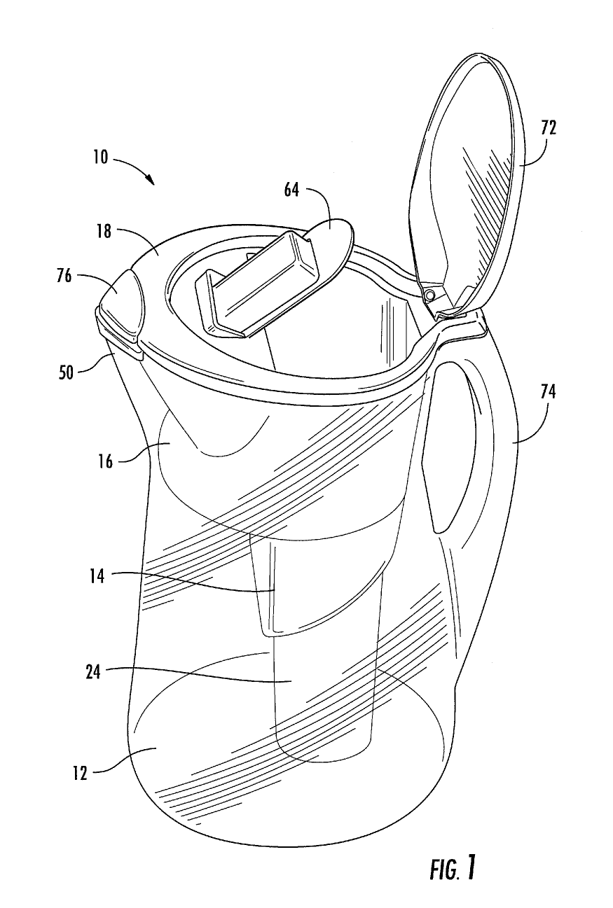

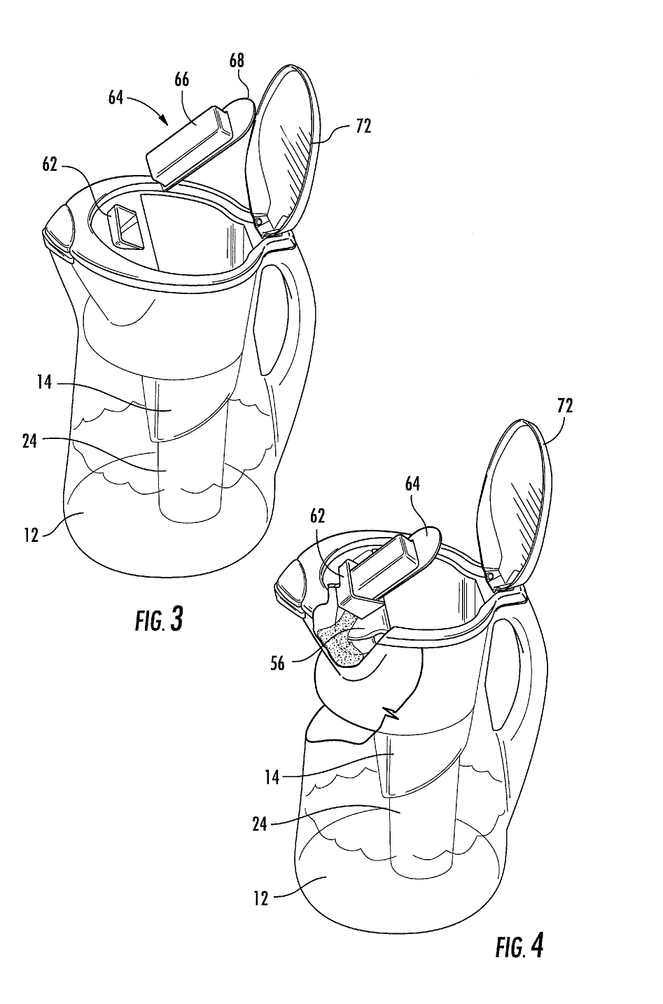

Referring now specifically to the drawings, a single serve water filtration and flavor additive device is illustrated in FIGS. 1 through 6 and are shown generally at reference numeral 10. Generally, the device 10 includes a lower reservoir 12, an upper reservoir 14, a flavor mixing device 16, and a pitcher top 18. The lower reservoir 12 comprises a base 20 and a top portion 22. A filter housing 24 is engaged to the upper reservoir 14 and extends downwardly within the lower reservoir 12 and toward the base 20 of the lower reservoir 12. A filter cartridge 26 is housed within the filter housing 24.

The lower reservoir 12 is designed to store filtered water. The pitcher top 18 is removably affixed to the top portion 22 of the lower reservoir 12. The upper reservoir 14 is designed to store unfiltered water prior to the water passing through the filter housing 24 and the filter cartridge 26, thus filtering the water and storing the filtered water in the lower reservoir 12. The upper reservoir 14 and filter housing 24 are in liquid communication with each other so that water can flow from the upper reservoir 14, into the filter housing 24, and then into the filter cartridge 26 where it is filtered prior to passing into the lower reservoir 12.

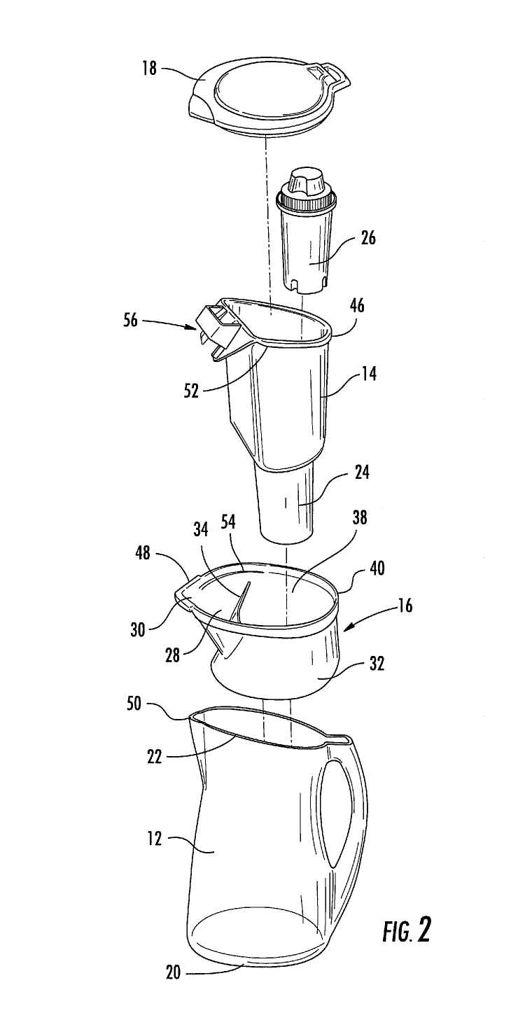

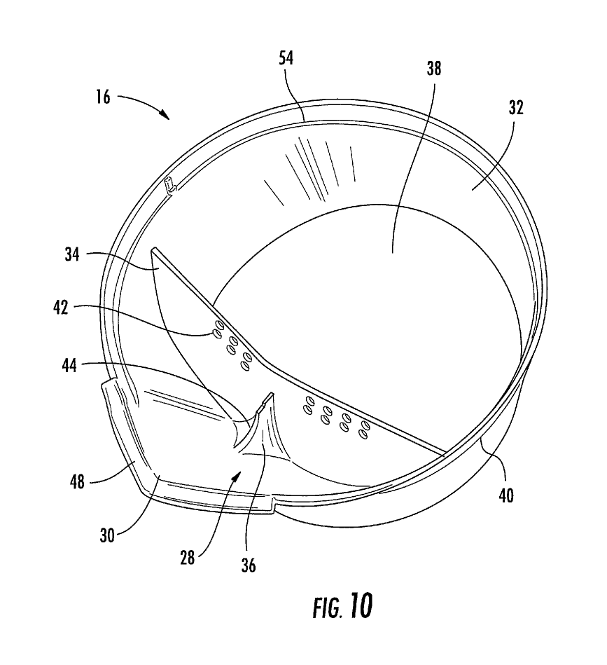

The flavor mixing device 16 is generally cylindrically shaped with a diameter slightly smaller than the diameter of the top portion 22 of the lower reservoir 12. The flavor mixing device 16 includes a mixing chamber 28, a mixing device spout 30, a retention ring 32, a water wall 34, a tongue 36, and a hollow cavity 38, as shown in FIG. 10. The water wall 34 extends from the interior of the retention ring 32 creating the mixing chamber 28. As illustrated in FIGS. 2 and 10, the water wall 34 is engaged to the retention ring 32, thus forming a mixing chamber 28 that is able to retain filtered water and allows the filtered water to exit the mixing device spout 30. The water wall 34 contains a plurality of bores 42 that concentrate the flow of water from the lower reservoir 12 and into the mixing chamber 28. The tongue 36 is disposed within the mixing chamber 28 and includes a chamfer 44. The mixing device spout 30 includes a skirt 48 that extends substantially perpendicular to the plane of the mixing device spout 30.

The top portion 22 of the lower reservoir 12 receives the lip 40 of the retention ring 32. The lip 40 of the retention ring 32 is placed upon the shelf 46 and suspended above the lower reservoir 12. The skirt 48 on the mixing device spout 30 sits atop the spout 50 of the lower reservoir 12.

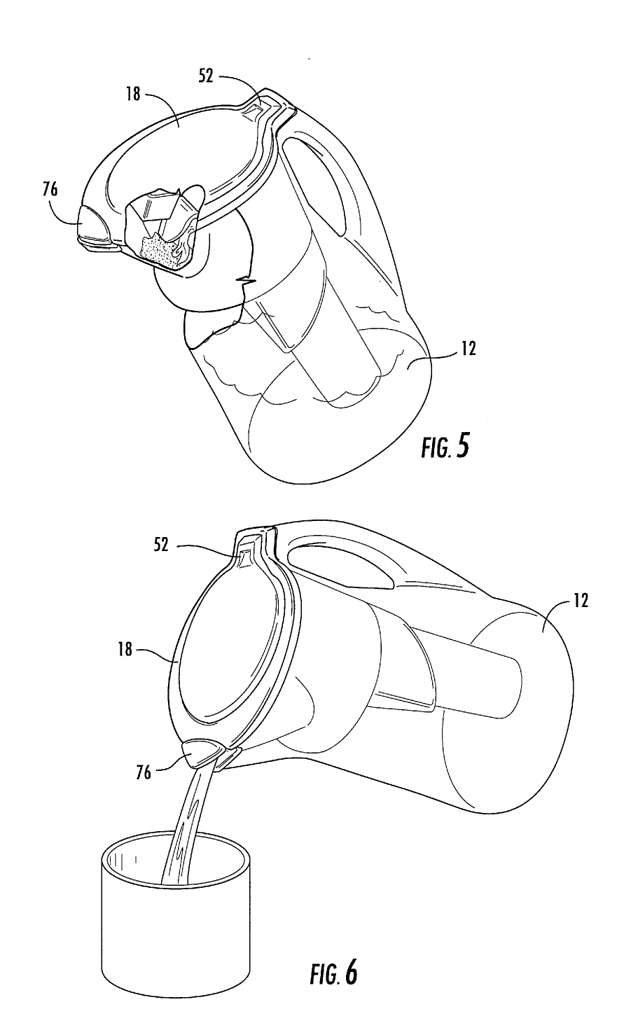

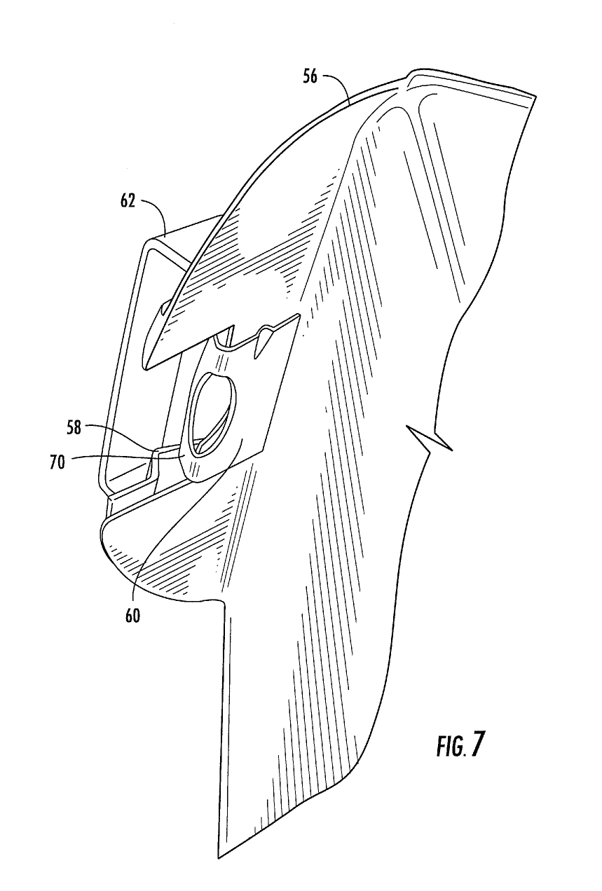

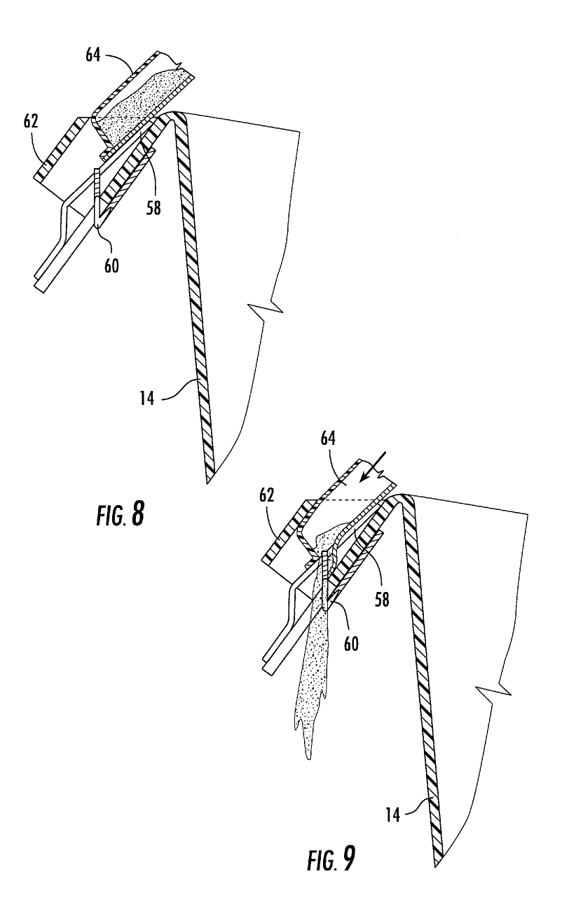

The upper reservoir 14 is received within the hollow cavity 38 of the flavor mixing device 16. The upper reservoir 14 contains a ring 52 that is disposed on a shelf 54 of the flavor mixing device 16. A flange 56 has a first portion and a second portion, wherein the second portion is engaged to the upper reservoir 14 and the second portion of the flange 56 is angled downward and into the mixing chamber 28 of the flavor mixing device 16. The second portion of the flange 56 is engaged to the chamfer 44 of the tongue 36. As shown in FIGS. 8 and 9, the flange 56 may include two spaced-apart and parallel ramps 58, an opening device 60, and a band 62 that encompasses the ramps 58 and opening device 60 and forming a cavity therein. When the upper reservoir 14 is disposed within the hollow cavity 38 of the flavor mixing device 16, a passage is formed between the upper reservoir 14 and flavor mixing device 16 that allows for filtered water to enter the passage when the device 10 is rotated to pour filtered water from the device 10, as shown in FIG. 6. The filtered water passes through the passage and flows into the mixing chamber 28 through the bores 42 disposed in the water wall 34. The band 62 protrudes through the pitcher top 72 for receiving the pod 64.

A pod 64 is designed to be inserted into the flange 56 for depositing a flavored powder into the mixing chamber 28 of the flavor mixing device 16. The pod 64 comprises a base 66 and a removable and/or resealable top 68. The pod 64 is designed to be inserted into the flange 56, and within the cavity formed by the band 62, with the top portion of the top 68 facing downward. The pod 64 is slide on the ramps 58 and toward the opening device 60. As illustrated in FIG. 7, the opening device 60 has an upwardly facing flange 70 that protrudes into the cavity formed by the band 62. The flange 70 of the opening device 60 peels the top 68 of the pod 64 backwards, thus exposing the contents contained within the pod 64. Alternatively, the flange 70 of the opening device 60 may puncture the top 68 of the pod 64, thus exposing the contents contained within the pod 64. The contents within the pod 64 may be a flavor additive that is in powder form. Alternatively, the flavor additive may be in the form of a paste, gel, or the like. The pod 64 may be squeezed to dispense the flavor additive, or alternatively, the flavor additive may simple fall out of the pod 64 and into the mixing chamber 28.

The pitcher top 18, includes a lid 72 that is designed to allow easy access to the upper reservoir 14. When the lid 72 is in the open position, the upper reservoir 14 is exposed and allows the user to pour water directly into the upper reservoir 14. The lid 72 may open by flipping, sliding, or otherwise moving to expose the upper reservoir 14. The pitcher top 18 also allows access to the flange 56.

During use, the user opens the lid 72 of the pitcher top 18 and pours water into the upper reservoir 14. As the water is poured into the upper reservoir 14 of the device 10, it flows downwardly through the upper reservoir 14 into the filter housing 24. The water is directed into the filter cartridge 26 and is filtered as it passes through the filter cartridge 26.

The rear side of the lower reservoir 12 contains a handle 74. The front side of the lower reservoir 12, meaning the side opposite the rear side, contains a spout 50. The spout 50 is formed out of the lower reservoir 12 and gradually protrudes from the top portion of the lower reservoir 12. The spout 50 is closed by a spout top 76. The spout top 50 is pivotally attached to the lid 16 by a horizontal hinge. The spout top 50 flips open when the device 10 is tilted for pouring water from the lower reservoir 14, as shown in FIG. 6.

To provide comfortable handling, a lever 78 is disposed on the handle 46. The lever 78 is designed to receive the thumb of a user and keeps the lid 16 engaged to the pitcher top 12. A user may depress the lever 78, thus opening the lid 16 for adding water to the upper reservoir 18.

During use, a user may lift the lid 72 of the pitcher top 18 to introduce unfiltered water into the upper reservoir 14. The upper reservoir 14 and filter housing 24 are in liquid communication with each other so that the unfiltered water can flow from the upper reservoir 14, into the filter housing 24, and then into the filter cartridge 26 where it is filtered prior to being deposited onto the base 20 of the lower reservoir 12. The filtered water is stored within the lower reservoir 12 until the user desires to pour the filtered water from the device 10 and infuse the filtered water with a flavor additive. The pod 64, containing flavor additive, is inserted into the opening device 60, wherein the pod 64 is inserted within the cavity formed by the band 62 and is slid along the ramps 68 until contact is made with the flange 70 of the opening device that peels back (or punctures) the top of the pod 64. Once the top of the pod 64 has been peeled back (or punctured), the user squeezes the base 66 of the pod 64 and deposits the flavor additive into the mixing chamber 28.

The user may tilt the device 10, causing filtered water to enter the passageway and flow through the bores 42 of the water wall 34 that produces a concentrated flow stream allowing for the expeditious mixing of the water with the flavor additive. After the filtered water has mixed with the flavor additive, the filtered water proceeds out of the mixing device spout 30 and into a cup or the like of the user for enjoyment.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A water filtration and flavor additive device comprising:
a lower reservoir for storing filtered water having a base and a top portion;
an upper reservoir;
a filter housing affixed to and extending below the upper reservoir, the filter housing adapted to contain a filter cartridge wherein the upper reservoir and the filter housing are in liquid communication, and
a mixing chamber for receiving a flavor additive and allowing for the mixture of the flavor additive and filtered water.

2. The water filtration and flavor additive device of claim 1, wherein the upper portion of the lower reservoir contains a shelf for receiving a retention ring that contains the mixing chamber, and the retention ring contains a cavity for receiving the upper reservoir forming a passageway for allowing filtered water stored within the lower reservoir to flow through the passageway and into the mixing chamber.

3. The water filtration and flavor additive device of claim 1, further comprising a spout disposed on the mixing chamber.

4. The water filtration and flavor additive device of claim 1, further comprising a flange disposed on the upper reservoir and extending into the mixing chamber, wherein the flange is angled for diverting the filtered water into the mixing chamber.

5. The water filtration and flavor additive device of claim 1, further comprising a water wall forming one side of the mixing chamber, the water wall contains a plurality of bores for allowing filtered water to flow into the mixing chamber.

6. The water filtration and flavor additive device of claim 1, further comprising a pitcher top that is engaged to the top portion of the lower reservoir.

7. The water filtration and flavor additive device of claim 1, further comprising a pitcher top that is engaged to the top portion of the lower reservoir that includes a lid for providing access to the upper reservoir and the mixing chamber.

8. A method of water filtration and adding flavor to water in a pitcher comprising:
providing a water filter pitcher wherein the water filter pitcher includes a lower reservoir having a base and a top portion for storing filtered water, an upper reservoir for holding unfiltered water, a filter housing affixed to and extending below the upper reservoir, the filter housing adapted to contain a filter cartridge wherein the upper reservoir and the filter housing are in liquid communication, and a mixing chamber for receiving a flavor additive;
adding water to the water filter pitcher,
permitting water to pass through the filter cartridge,
collecting filtered water in the lower reservoir, and
tilting the pitcher to allow the filtered water to pass through the mixing chamber, causing the filtered water to mix with the flavor additive.

9. The method of water filtration and adding water flavor to water of claim 8, wherein the upper portion of the lower reservoir contains a shelf for receiving a retention ring that contains the mixing chamber, and the retention ring contains a cavity for receiving the upper reservoir forming a passageway for allowing filtered water stored within the lower reservoir to flow through the passageway and into the mixing chamber.

10. The method of water filtration and adding water flavor to water of claim 8, further comprising providing a pod having a base, a top, and a flavor additive contained within the pod and placing the pod in an opening device for depositing the flavor additive into the mixing chamber.

11. The method of water filtration and adding water flavor to water of claim 8, further comprising a pitcher top that is engaged to the top portion of the lower reservoir.

12. The method of water filtration and adding water flavor to water of claim 8, further comprising a retention ring and a water wall, whereby the water wall is engaged to the retention ring and forming the mixing chamber, the water wall includes a plurality of bores for allowing water to enter the mixing chamber.

13. The method of water filtration and adding water flavor to water of claim 8, further comprising a lower reservoir that has a handle and a spout.

14. A water filtration and flavor additive device comprising:
a lower reservoir for storing filtered water having a base and a top portion;
an upper reservoir;
a filter housing affixed to and extending below the upper reservoir, the filter housing adapted to contain a filter cartridge wherein the upper reservoir and the filter housing are in liquid communication, and
a retention ring that is engaged to the top portion of the lower reservoir and has a cavity and a water wall, wherein the water wall is engaged to the retention ring forming a mixing chamber therein for receiving a flavor additive and allowing for the mixture of the flavor additive and filtered water, and the cavity receives the upper reservoir and suspends the upper reservoir within the lower reservoir.

15. The water filtration and flavor additive device of claim 14, further comprising the lower reservoir contains a handle and a spout.

16. The water filtration and flavor additive device of claim 14, further comprising a pitcher top that is engaged to the top portion of the lower reservoir.

17. The water filtration and flavor additive device of claim 14, further comprising a pitcher top that is engaged to the top portion of the lower reservoir, wherein the pitcher top contains a lid for providing access to the upper reservoir and the mixing chamber.

18. The water filtration and flavor additive device of claim 14, further comprising an opening device disposed on the upper reservoir for receiving a pod containing a flavor additive.

19. The water filtration and flavor additive device of claim 14, further comprising a water wall with bores therein for allowing water to flow through the water wall and into the mixing chamber.

20. The water filtration and flavor additive device of claim 14, further comprising a ring on the upper reservoir that engaged the retention ring for suspending the upper reservoir within the lower reservoir.
